(19) United States
(12) Patent Application Publication
(10) Pub. No.: US 2018/0208261 A1
(43) Pub. Date: Jul. 26, 2018

(54) MECHANICAL VEHICLE SUPPLEMENTARY SYSTEM

(71) Applicant: Wing Young Co., Ltd., Taoyuan (TW)

(72) Inventors: Hsien-Cheng CHEN, Taoyuan (TW); Wei-Lun CHEN, Taoyuan (TW); Mao-Pang CHEN, Taoyuan (TW)

(21) Appl. No.: 15/864,174

(22) Filed: Jan. 8, 2018

(30) Foreign Application Priority Data
Jan. 20, 2017 (TW) 106102274

(51) Int. Cl. B62H 1/12

(52) U.S. Cl. CPC B62H 1/12

(57) ABSTRACT

A mechanical vehicle supplementary system includes a bracket including top mounting members for fastening to a bottom side of a vehicle, a first sleeve and a second sleeve respectively located at two opposite ends thereof and first and second elastic members respectively mounted in the first and second sleeves, a first support bar having one end axially slidably supported on the first elastic member inside the first sleeve and an opposite end disposed outside the first sleeve and equipped with a first wheel supportable on the ground, and a second support bar having one end axially slidably supported on the second elastic member inside the second sleeve and an opposite end disposed outside the second sleeve and equipped with a second wheel supportable on the ground.

This application claims the priority benefit of Taiwan patent application number 106102274, filed on Jan. 20, 2017.

### BACKGROUND OF THE INVENTION

### 1. Field of the Invention

The present invention relates to mechanical vehicle technology and more particularly, to a mechanical vehicle supplementary system for use in a two-wheel vehicle to give support to the two-wheel vehicle when the two-wheel vehicle is inclining, keeping the two-wheel vehicle in balance.

### 2. Description of the Related Art

Many two-wheel vehicle supplementary devices have been created for use in a bicycle, motorcycle or other two-wheel vehicle to ensure riding balance, avoiding dumping. According to conventional techniques, micro switches, relays and transmission devices are used to mate with forward and backward rotation of a motor in controlling a pulling rod to move an auxiliary wheel bracket upward or downward.

To let the auxiliary wheel be lowered when the vehicle speed is slowed down, the auxiliary wheel bracket and the auxiliary wheel can be released subject to the control of a speed sensor or control switch, or by means of manually operating the accelerator or throttle handle.

Further, conventional two-wheel vehicle supplementary devices do not provide any elastic buffer design to buffer shocks. According to actual riding and road conditions, when the two-wheel vehicle supplementary device hits the rod as the rider turns the direction and reduces the speed, or the vehicle is running over an uneven road surface, a reactive force will be given to the vehicle, causing vibrations and resulting in the loss of riding balance and affecting riding safety. Therefore, conventional vehicle supplementary device designs are still not satisfactory in function and have room for improvement.

### SUMMARY OF THE INVENTION

The present invention has been accomplished under the circumstances in view. It is therefore the main object of the present invention to provide a mechanical vehicle supplementary system, which comprises a bracket, a first support bar and a second support bar. The bracket comprises a plurality of mounting members located at the top side thereof for fastening to a bottom side of a vehicle, a first sleeve and a second sleeve respectively located at two opposite ends thereof, and first and second elastic members respectively mounted in the first and second sleeves. The first support bar is axially slidably mounted in the first sleeve, having one end thereof supported on the first elastic member inside the first sleeve and an opposite end disposed outside the first sleeve and equipped with a first wheel supportable on the ground. The second support bar is axially slidably mounted in the second sleeve, having one end thereof supported on the second elastic member inside the second sleeve and an opposite end disposed outside the second sleeve and equipped with a second wheel supportable on the ground.

The mechanical vehicle supplementary system has the effects: when the two-wheel vehicle is inclining, the first support bar or second support bar abuts against the first elastic member or second elastic member to support the inclined side of the two-wheel vehicle, keeping the two-wheel vehicle in balance, avoiding slipping and falling accidents.

Other advantages and features of the present invention will be fully understood by reference to the following specification in conjunction with the accompanying drawings, in which like reference signs denote like components of structure.

### BRIEF DESCRIPTION OF THE DRAWINGS

FIG. 1 is a schematic perspective view of a mechanical vehicle supplementary system in accordance with a first embodiment of the present invention.

FIG. 2 is a schematic side view illustrating the mechanical vehicle supplementary system of the first embodiment of the present invention installed in a two-wheel vehicle.

FIG. 3 is a rear side view of FIG. 2.

FIG. 4 is a schematic drawing illustrating a working status of the mechanical vehicle supplementary system of the first embodiment of the present invention.

FIG. 5 is a schematic elevational view of a mechanical vehicle supplementary system in accordance with a second embodiment of the present invention.

FIG. 6 is an enlarged view of a part of FIG. 5.

### DETAILED DESCRIPTION OF THE PREFERRED EMBODIMENT

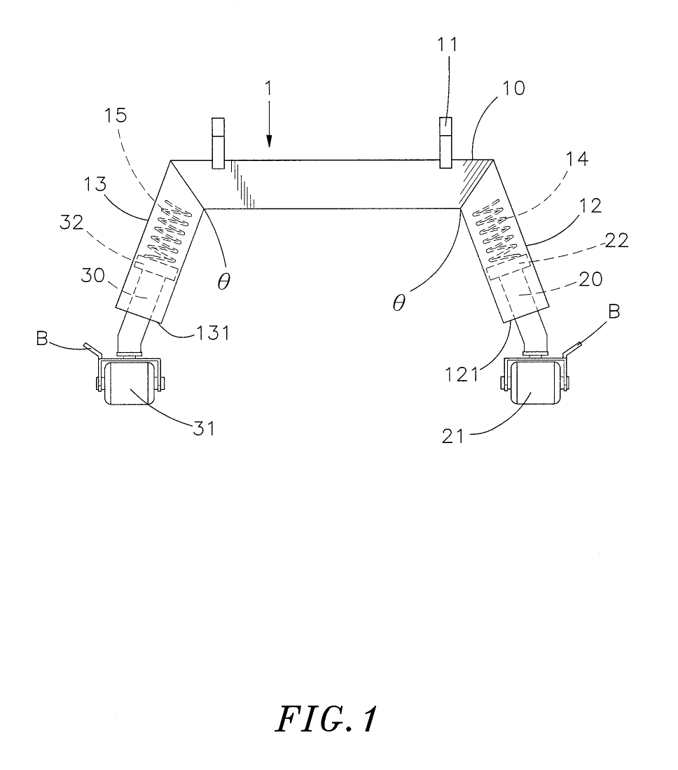

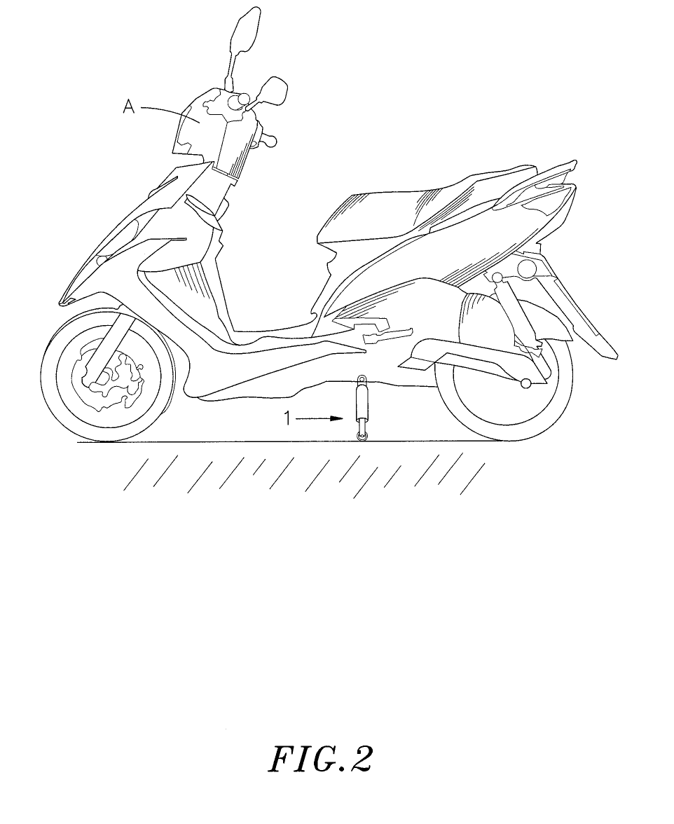

Referring to FIGS. 1 and 2, a mechanical vehicle supplementary system 1 in accordance with a first embodiment of the present invention is shown. The mechanical vehicle supplementary system 1 comprises a bracket 10, a first support bar 20 and a second support bar 30.

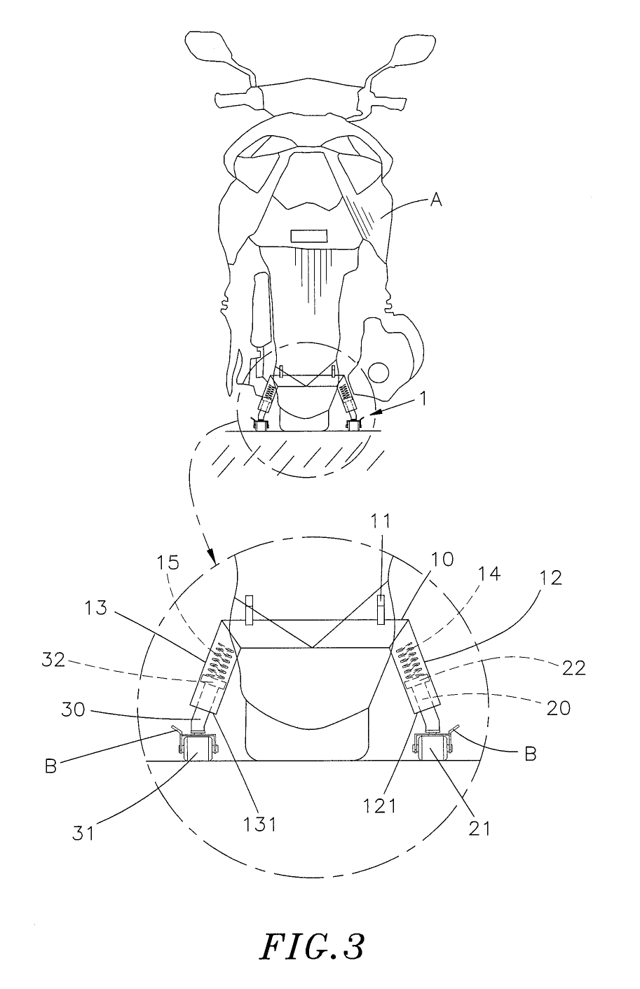

Referring to FIG. 3 and FIGS. 1 and 2 again, the bracket 10 comprises a plurality of mounting members 11 located at a top side thereof for fastening to a bottom side of a vehicle A, a first sleeve 12 located at one end thereof, a second sleeve 13 located at an opposite end thereof, a first elastic member 14 mounted in the first sleeve 12, and a second elastic member 15 mounted in the second sleeve 13.

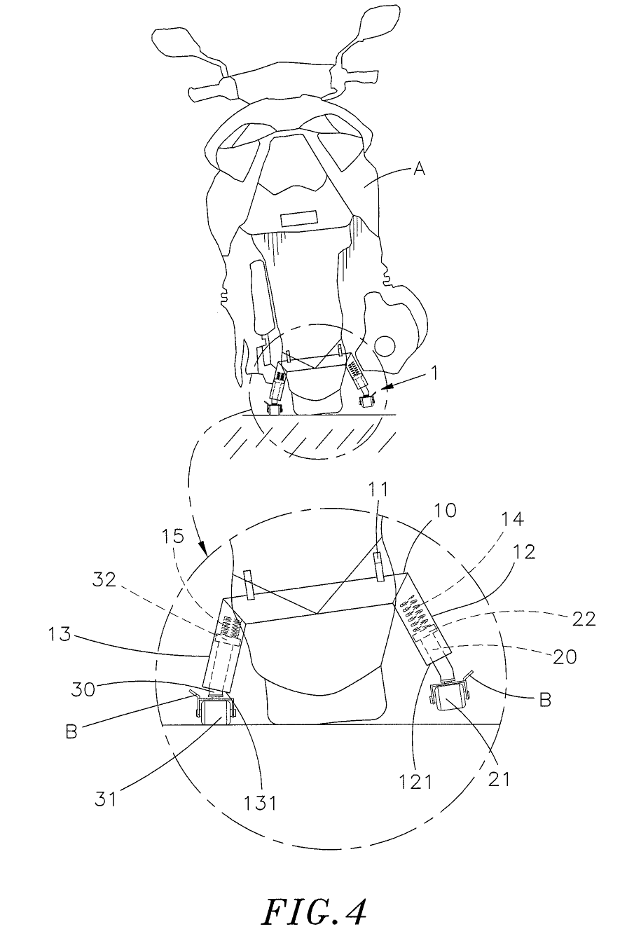

Referring to FIG. 4, the first support bar 20 is axially slidably mounted in the first sleeve 12, namely, an inner end of the first support bar 20 supported on the first elastic member 14 inside the first sleeve 12 and the outer end of the first support bar 20 extended out of the first sleeve 12 and equipped with at least one first wheel 21. The at least one first wheel 21 is supported on the floor so that the first support bar 20 is axially movable in the first sleeve 12 to compress the first elastic member 14.

The second support bar 30 is axially slidably mounted in the second sleeve 13, namely, an inner end of the second support bar 30 supported on the second elastic member 15 inside the second sleeve 13 and the outer end of the second support bar 30 extended out of the second sleeve 13 and equipped with at least one second wheel 31. The at least one second wheel 31 is supported on the floor so that the second support bar 30 is axially movable in the second sleeve 13 to compress the second elastic member 15.

Referring to FIGS. 1-4 again, the first sleeve 12 comprises a first internal flange 121 extended around an inside wall of a distal end of the bracket 10; the first support bar 20 comprises a first stop flange 22 extended around the periphery of the inner end of the first support bar 20 thereof and stopped against the first elastic member 14. The inner diameter of the first internal flange 121 is smaller than the outer diameter of the first stop flange 22. Thus, when the first support bar 20 is forced by the first elastic member 14 to move toward the outside of the first sleeve 12, the first stop flange 22 will be stopped by the first internal flange 121 inside the first sleeve 12, prohibiting the first support bar 20 from falling out of the first sleeve 12.

The second sleeve 13 comprises a second internal flange 131 extended around an inside wall of a distal end of the bracket 10; the second support bar 30 comprises a second stop flange 32 extended around the periphery of the inner end of the second support bar 30 thereof and stopped against the second elastic member 15. The inner diameter of the second internal flange 131 is smaller than the outer diameter of the second stop flange 32. Thus, when the second support bar 30 is forced by the second elastic member 15 to move toward the outside of the second sleeve 13, the second stop flange 32 will be stopped by the second internal flange 131 inside the second sleeve 13, prohibiting the second support bar 30 from falling out of the second sleeve 13.

The mechanical vehicle supplementary system 1 further comprises a brake unit B mounted at each of the at least one first wheel 21 and the at least one second wheel 31 for stopping the at least one first wheel 21 and the at least one second wheel 31 from rotation.

The bracket 10 respectively defines with the first sleeve 12 and the second sleeve 13 a predetermined contained angle θ. The contained angle θ is within the range of 30°˜80°.

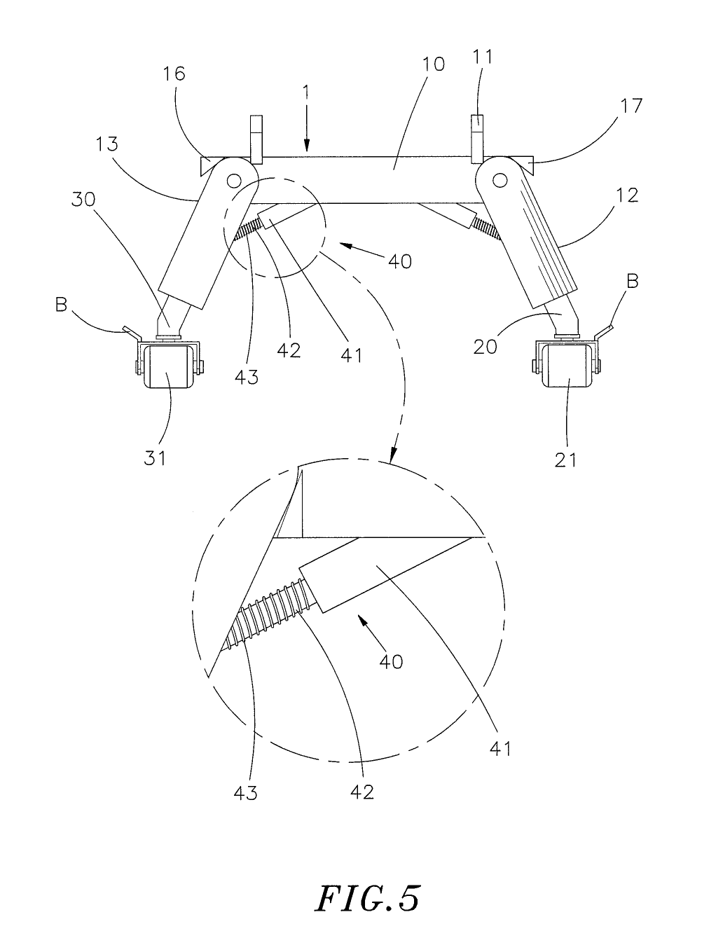

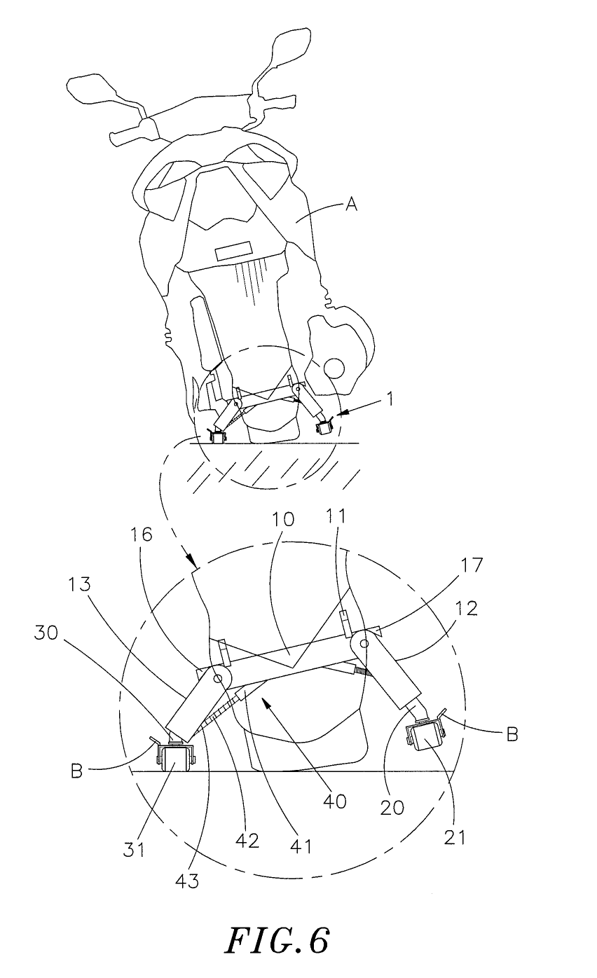

Referring to FIGS. 5 and 6, a mechanical vehicle supplementary system 1 in accordance with a second embodiment of the present invention is shown. This second embodiment is substantially similar to the aforesaid first embodiment with the exceptions as described hereinafter. In this second embodiment, the first sleeve 12 and the second sleeve 13 are respectively pivotally connected to the bracket 10; the bracket 10 further comprises two first stop flanges 16 and two second stop flanges 17 so arranged that the first support bar 20 pivots between the two first stop flanges 16; the second support bar 30 pivots between the two second stop flanges 17.

The bracket 10 further comprises two retractable units 40. Each retractable unit 40 comprises a barrel 41, a retractable rod 42 and a third elastic member 43. The barrel 41 has one end thereof connected to the bracket 10. The retractable rod 42 has one end thereof axially slidably mounted in the barrel 41, and an opposite end thereof pivotally connected to the first sleeve 12 or second sleeve 13. The third elastic member 43 is mounted around the retractable rod 42 and stopped between the barrel 41 and the first sleeve 12 or second sleeve 13. Thus, when the vehicle changes the direction during running, the first sleeve 12 and the second sleeve 13 can be relatively pivoted relative to the vehicle the bracket 10 to keep the vehicle in balance, enhancing steering safety.

Although particular embodiments of the invention have been described in detail for purposes of illustration, various modifications and enhancements may be made without departing from the spirit and scope of the invention. Accordingly, the invention is not to be limited except as by the appended claims.

What the invention claimed is:

1. A mechanical vehicle supplementary system, comprising:
a bracket comprising a plurality of mounting members located at a top side thereof for fastening to a bottom side of a vehicle, a first sleeve and a second sleeve respectively located at two opposite ends of said bracket thereof, a first elastic member mounted in said first sleeve and a second elastic member mounted in said second sleeve;
a first support bar axially slidably mounted in said first sleeve, said first sleeve having an inner end thereof disposed inside said first sleeve and supported on said first elastic member and an opposing outer end thereof disposed outside said first sleeve and equipped with at least one first wheel for supporting on the ground; and
a second support bar axially slidably mounted in said second sleeve, said second sleeve having an inner end thereof disposed inside said second sleeve and supported on said second elastic member and an opposing outer end thereof disposed outside said second sleeve and equipped with at least one second wheel for supporting on the ground.

2. The mechanical vehicle supplementary system as claimed in claim 1, wherein said first sleeve comprises a first internal flange extended around an inner wall of a distal end thereof; said first support bar comprises a first stop flange extended around the periphery of the inner end thereof and stopped against said first elastic member and stoppable by said first internal flange inside said first sleeve; said second sleeve comprises a second internal flange extended around an inner wall of a distal end thereof; said second support bar comprises a second stop flange extended around the periphery of the inner end thereof and stopped against said second elastic member and stoppable by said second internal flange inside said second sleeve.

3. The mechanical vehicle supplementary system as claimed in claim 1, wherein a brake unit is respectively mounted at each of said at least one first wheel and said at least one second wheel for stopping respective each of said at least one first wheel and said at least one second wheel from rotation.

4. The mechanical vehicle supplementary system as claimed in claim 1, wherein said bracket defines with said first sleeve a first predetermined contained angle; said bracket defines with said second sleeve a second predetermined contained angle.

5. The mechanical vehicle supplementary system as claimed in claim 4, wherein said first predetermined angle and said second predetermined angle are within the range of 30°˜80°.
